(19) United States
(12) Patent Application Publication
(10) Pub. No.: US 2008/0075276 A1
(43) Pub. Date: Mar. 27, 2008

(54) Method for controlling the switch of the electronic device

(76) Inventor: Chung-Ming Sun, Yonghe City (TW)

Correspondence Address: TROXELL LAW OFFICE PLLC, SUITE 1404, 5205 LEESBURG PIKE, FALLS CHURCH, VA, 22041, US

(21) Appl. No.: 11/526,106

(22) Filed: Sep. 25, 2006

(51) Int. Cl. H04L 9/28

(52) U.S. Cl. 380/28

(57) ABSTRACT

A method for controlling the switch of the electronic device includes the following steps: Step (a): Providing a portable cipher code generating device and an electronic device; the cipher code generating device includes a first time-generating unit and an operating-hour unit capable of providing an input while the electronic device includes a cipher-code decoding device; Step (b): By the use of the operating-hour unit, inputting an operating-hour parameter and acquiring a time-parameter to make the cipher code generating device figure out a cipher-code set; Step (c): Providing the cipher-code decoding device with an indicatory parameter; Step (d): Performing comparison between the indicatory parameter and the cipher-code set; Step (e): The electronic device performs the action of the operating-hour parameter when the indicatory parameter is corresponding with the cipher-code set, and the electronic device does not perform the action of the operating-hour parameter when the indicatory parameter is not corresponding with the cipher-code set.

### BACKGROUND OF THE INVENTION

1. Field of the Invention

The invention relates to a method for controlling the switch of the electronic device, and more particularly, to a method for remotely controlling the switch of the electronic device that is capable of performing the timing and switching.

2. Description of the Prior Art

The high technology advances with giant strides by leaps and bounds in recent years, especially, it renews and changes with each passing day in the field of micro-electronic related techniques and processes. Therefore, the electronic relevant products have gone deep into every family and all walks of life and become indispensable portions of our modern life.

According to a Chinese old saying, water is capable of carrying the boat, however, it is capable of overturning the boat as well. As the demands of human being become more and more, relatively, the usage of the electronic device must be achieved as multi-functional. The general users of electronic devices, especially the children, often indulge themselves in using the electronic devices for long hours resulting in civilized diseases such as nearsighted. As people are very busy nowadays, parents are unable to take times in taking care of their children very often, just how to resolve the above-mentioned problems has become an important issue for the electronic device companies in pursuit of improving their products.

### SUMMARY OF THE INVENTION

In light of the disadvantages of the prior arts, the invention provides a method for controlling the switch of the electronic device that aims to ameliorate at least some of the disadvantages of the prior art or to provide a useful alternative.

The primary objective of the invention is to provide a method for controlling the switch of the electronic device that utilizes a generated cipher code (secret code) of a predetermined time switch to inform the controlled receiving end of inputting the cipher code for making comparison so as to achieve the efficacy of remotely controlling the predetermined time switch.

It is another objective of the invention to provide a method for controlling the switch of the electronic device that utilizes the cipher-code's characteristic which varies with time to achieve the efficacy that the cipher code is limited to be effective only in a specific time.

To attain the above-mentioned objectives, the invention provides a method for controlling the switch of the electronic device that includes the following steps:
Step (a): Providing a portable cipher code generating device and an electronic device; the cipher code generating device includes a first time-generating unit, an operating-hour unit capable of providing an input, and a first mathematic operation unit while the electronic device includes a cipher-code decoding device having a second time-generating unit that is corresponding to the first time-generating unit and a second mathematic operation unit that is corresponding to the first mathematic operation unit;
Step (b): By the use of the operating-hour unit, inputting an operating-hour parameter and acquiring a first time-parameter generated by the first time-generating unit, then operating by the use of the first mathematic operation unit to make the cipher code generating device figure out a cipher-code set;
Step (c): Providing the cipher-code decoding device with an indicatory parameter or directly providing the cipher-code decoding device with cipher-code set;
Step (d): Performing comparison between the indicatory parameter and the cipher-code set, at this moment, the second time-generating unit generates a second time-parameter and the second mathematic operation unit is used to figure out the operating-hour parameter;
Step (e): The electronic device performs the action of the operating-hour parameter when the indicatory parameter is corresponding with the cipher-code set, and the electronic device does not perform the action of the operating-hour parameter when the indicatory parameter is not corresponding with the cipher-code set.

### BRIEF DESCRIPTION OF THE DRAWINGS

The accomplishment of this and other objectives of the invention will become apparent from following description and its accompanying drawings of which:

FIG. 1 is an isometric-and-schematic view showing the disposition of the device for controlling the switch thereof of the preferred embodiment of the invention;

FIG. 2 is an schematic flow chart showing the method for controlling the switch of the electronic device of the preferred embodiment of the invention.

### DETAILED DESCRIPTION OF THE PREFERRED EMBODIMENT

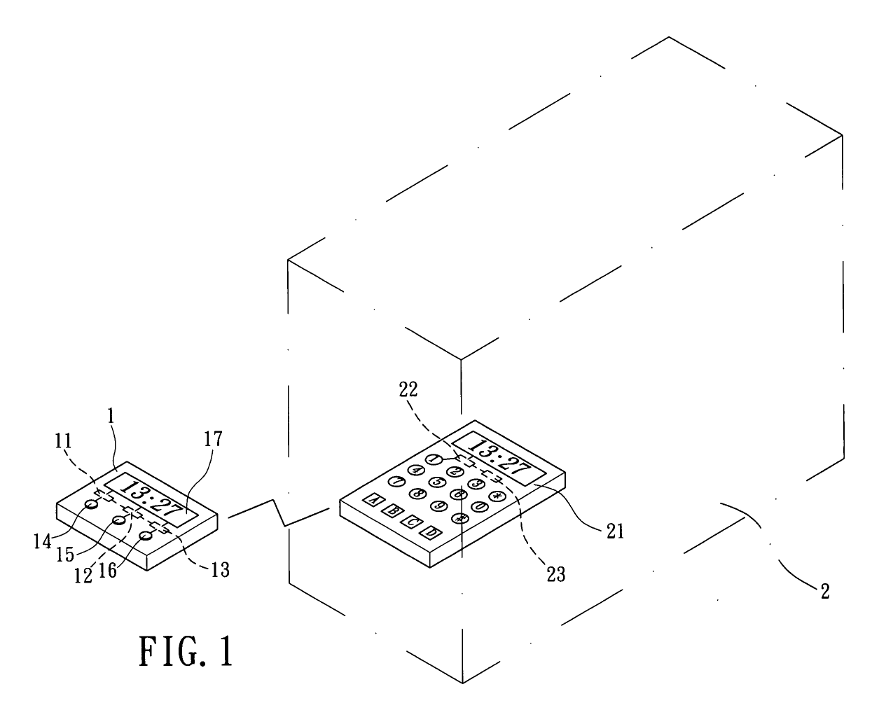

FIG. 1 is an isometric-and-schematic view showing the disposition of the device for controlling the switch thereof of the preferred embodiment of the invention. As shown in FIG. 1, the method for controlling the switch of the electronic device of the invention includes a cipher-code generating device (1) and an electronic device (2). The cipher-code generating device (1) capable of providing a user to carry along further includes a first time-generating unit (11) and an operating-hour unit (12) capable of providing an input. The first time-generating unit (11) sets up in accordance with the data of year, month, day, hour, minute by a set-up key (14) and is capable of displaying on an LCD screen (17). While the operating-hour unit (12), after inputting an operating-hour parameter by a controlling key (15), acts on a generating key (16). At this moment, the cipher code generating device (1) having a predetermined first mathematic operation unit (13) is capable of figuring out a cipher-code set by utilizing a first time-parameter as reference variable wherein the first time-parameter is acquired by the operating-hour parameter and the first time-generating unit at this moment.

The electronic device (2) includes a cipher-code decoding device (21) that has a second time-generating unit (22). The second time-generating unit (22) not only has a second mathematic operation unit (23) that is the same as the first mathematic operation unit (13), but also has the data of year, month, day, hour, minute corresponding to the first time-generating unit (11). In the preferred embodiment of the invention, if the electronic device (2) is a computer, the computer has the second time-generating unit (22) having the time program corresponding to the first time-generating unit (11). Therefore, only the program software of the second mathematic operation unit (23) that is the same as the first mathematic operation unit (13) needs to be implemented.

As mentioned above, when the user directly provides the cipher-code decoding device (21) with cipher-code set, the second time-generating unit (22) is capable of generating a second time-parameter and figuring out the operating-hour parameter by the use of the second mathematic operation unit (23) to make the electronic device (2) perform the action of the operating-hour parameter. The user can also provide the cipher-code decoding device (21) with an indicatory parameter. In this case, the cipher-code decoding device (21) is capable of comparing the indicatory parameter with the cipher-code set such that the electronic device performs the action of the operating-hour parameter when the indicatory parameter is corresponding with the cipher-code set, and the electronic device does not perform the action of the operating-hour parameter when the indicatory parameter is not corresponding with the cipher-code set.

In another embodiment of the invention, the electronic device (2) further includes a control portion (e.g. a remote control) having the cipher-code decoding device (21) disposed therein. The control portion is capable of providing the input of the indicatory parameter to make the cipher-code decoding device (21) perform the comparison between the indicatory parameter and the cipher-code set. Of cause, the invention is also capable of providing the indicatory parameter with inputting to the cipher-code decoding device (21) by the tone frequency signal of the telephone “dual tone multiple frequency” (DTMF), or position the cipher-code decoding device (21) in a computer (and the electronic device (21) is also a computer) to provide the cipher-code decoding device (21) with indicatory parameter through the world wide web. All these variations of design can be executed by those people skilled in the art in accordance with the above-mentioned description, thereby, without departing from the scope or spirit of the invention. Therefore, it is not necessary to go into details.

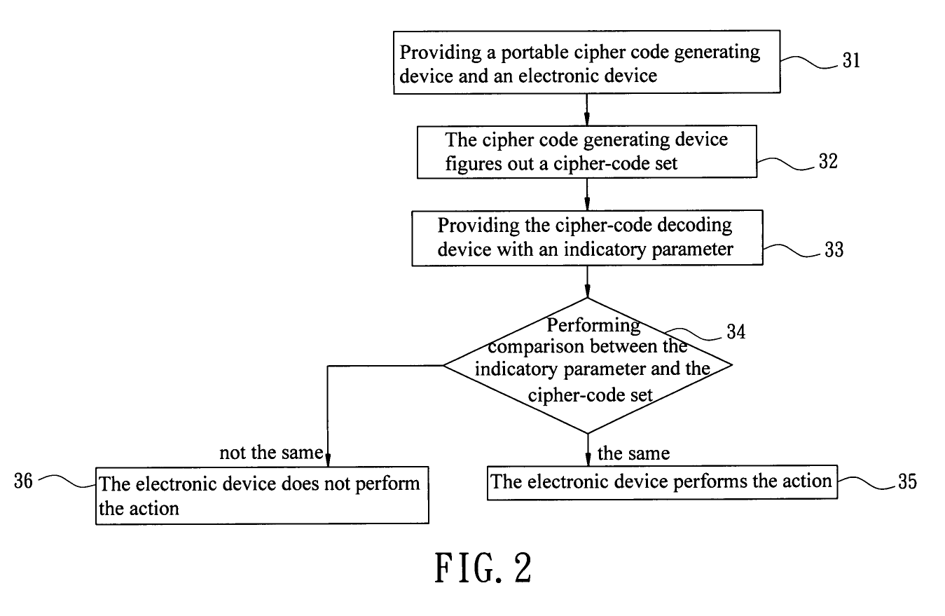

FIG. 2 is an schematic flow chart showing the method for controlling the switch of the electronic device of the preferred embodiment of the invention. As shown in FIG. 2, the method for controlling the switch of the electronic device includes the following steps:
Step (a): Providing a portable cipher code generating device and an electronic device (31); the cipher code generating device includes a first time-generating unit, an operating-hour unit capable of providing an input, and a first mathematic operation unit while the electronic device includes a cipher-code decoding device having a second time-generating unit corresponding to the first time-generating unit and a second mathematic operation unit corresponding to the first mathematic operation unit;
Step (b): By the use of the operating-hour unit, inputting an operating-hour parameter and acquiring a first time-parameter generated by the first time-generating unit, then operating by the use of the first mathematic operation unit to make the cipher code generating device figure out a cipher-code set (32);
Step (c): Providing the cipher-code decoding device with an indicatory parameter (33) or directly providing the cipher-code decoding device with cipher-code set;
Step (d): Performing comparison between the indicatory parameter and the cipher-code set (34), at this moment, the second time-generating unit generates a second time-parameter and the second mathematic operation unit is used to figure out the operating-hour parameter;
Step (e): The electronic device performs the action of the operating-hour parameter when the indicatory parameter is corresponding with the cipher-code set (35), and the electronic device does not perform the action of the operating-hour parameter when the indicatory parameter is not corresponding with the cipher-code set (36).

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A method for controlling the switch of the electronic device comprising the following steps:
(a) Providing a portable cipher code generating device and an electronic device; the cipher code generating device includes a first time-generating unit and an operating-hour unit capable of providing an input while the electronic device includes a cipher-code decoding device;
(b) By the use of the operating-hour unit, inputting an operating-hour parameter and acquiring a time-parameter generated by the time generating unit to make the cipher code generating device figure out a cipher-code set;
(c) Providing the cipher-code decoding device with an indicatory parameter or directly providing the cipher-code decoding device with cipher-code set;
(d) Performing comparison between the indicatory parameter and the cipher-code set; and
(e): The electronic device performs the action of the operating-hour parameter when the indicatory parameter is corresponding with the cipher-code set, and the electronic device does not perform the action of the operating-hour parameter when the indicatory parameter is not corresponding with the cipher-code set.

2. The method for controlling the switch of the electronic device as claimed in claim 1, wherein the time-generating unit generates the time-parameter respectively in accordance with the data of year, month, and day.

3. The method for controlling the switch of the electronic device as claimed in claim 1, wherein the cipher code generating device has a predetermined first mathematic operation program and employs the operation hour and the time parameter as reference variable.

4. The method for controlling the switch of the electronic device as claimed in claim 3, wherein the electronic device has a second mathematic operation program that is corresponding with the first mathematic operation program.

5. The method for controlling the switch of the electronic device as claimed in claim 3, wherein the electronic device is a computer that has a software of a second mathematic operation program that is corresponding with the first mathematic operation program.

6. The method for controlling the switch of the electronic device as claimed in claim 1, wherein the cipher-code decoding device being positioned in a computer and the electronic device being also a computer provides the cipher-code decoding device with indicatory parameter through the world wide web.

7. The method for controlling the switch of the electronic device as claimed in claim 1, wherein the electronic device further includes a control portion having the cipher-code decoding device disposed therein, the control portion is capable of providing the input of the indicatory parameter to make the cipher-code decoding device perform the comparison between the indicatory parameter and the cipher-code set.

8. The method for controlling the switch of the electronic device as claimed in claim 1, wherein the step (c) is capable of providing the indicatory parameter with inputting to the cipher-code decoding device through the telephone network by the tone frequency signal of the telephone “dual tone multiple frequency” (DTMF).

9. A method for controlling the switch of the electronic device comprising the following steps:
(a) Providing a portable cipher code generating device and an electronic device, the cipher code generating device comprises a first time-generating unit, an operating-hour unit capable of providing an input, and a first mathematic operation unit, while the electronic device comprises a cipher-code decoding device having a second time-generating unit that is corresponding to the first time-generating unit and a second mathematic operation unit that is corresponding to the first mathematic operation unit;
(b) By the use of the operating-hour unit, inputting an operating-hour parameter and acquiring a first time-parameter generated by the first time-generating unit to make the cipher code generating device figure out a cipher-code set by performing mathematic operation utilizing the first mathematic operation unit;
(c) Providing the cipher-code decoding device with the cipher-code set;
(d) Using the second time-generating unit to generate a second time-parameter and using the second mathematic operation unit to figure out the operating-hour parameter; and
(e): The electronic device performs the action of the operating-hour parameter.

10. The method for controlling the switch of the electronic device as claimed in claim 9, wherein the first time-generating unit and the second time-generating unit generates the first time-parameter and the second time-parameter respectively in accordance with the data of year, month, and day.

11. The method for controlling the switch of the electronic device as claimed in claim 9, wherein the electronic device is a computer and the second mathematic operation unit is a software.

12. The method for controlling the switch of the electronic device as claimed in claim 9, wherein the cipher-code decoding device being positioned in a computer and the electronic device being also a computer provides the cipher-code decoding device with indicatory parameter through the world wide web.

13. The method for controlling the switch of the electronic device as claimed in claim 9, wherein the electronic device further includes a control portion having the cipher-code decoding device disposed therein, and the control portion is capable of providing the input of the cipher-code set to perform the action of the electronic device.

14. The method for controlling the switch of the electronic device as claimed in claim 9, wherein the step (c) is capable of providing the cipher-code set with inputting to the cipher-code decoding device through the telephone network by the tone frequency signal of the telephone “dual tone multiple frequency” (DTMF).
